(19) United States
(12) Patent Application Publication
(10) Pub. No.: US 2025/0247801 A1
(43) Pub. Date: Jul. 31, 2025

(54) ULTRA-WIDEBAND CLUSTER SCHEDULING OPTIMIZER

(71) Applicant: Cisco Technology, Inc., San Jose, CA (US)

(72) Inventors: Jerome HENRY, Pittsboro, NC (US); Matthew A. SILVERMAN, Shaker Heights, OH (US); Robert E. BARTON, Richmond (CA); Robert C. BADEA, Broadview Heights, OH (US)

(21) Appl. No.: 18/428,517

(22) Filed: Jan. 31, 2024

(51) Int. Cl. H04W 56/00; H04W 24/02

(52) U.S. Cl. CPC H04W 56/001; H04W 24/02

(57) ABSTRACT

Techniques relating to ultra-wideband (UWB) wireless communications include identifying a plurality of clusters for UWB time difference of arrival (TDOA) ranging, where each cluster includes an initiating anchor to transmit a plurality of UWB messages to wireless devices for TDOA ranging. These techniques further include forming a first supercluster including a first two or more clusters, and a second supercluster including a second two or more clusters, based on determining that a respective initiating anchor associated with each of the two or more clusters in the first supercluster is radio frequency (RF) isolated from respective recipient anchors associated with each of the two or more clusters in the second supercluster. The techniques further include conducting TDOA ranging using the plurality of clusters, based on scheduling transmission of UWB messages in parallel from initiating anchors in both the first and second superclusters.

### TECHNICAL FIELD

Embodiments presented in this disclosure generally relate to wireless communications. More specifically, one or more embodiments disclosed herein relate to ultra-wideband (UWB) wireless communications.

### BACKGROUND

Industrial Internet of Things (IoT) environments are increasingly using wireless to manage and control autonomous vehicles. Examples include ports, mines, theme parks, and a variety of other environments. As this technology develops, pinpointing the location of moving connected things has become increasingly important.

One promising technology that is being developed is Ultra-wideband (UWB), defined by the FiRa Consortium, among other organizations. The FiRa technical specifications are based on High-Rate Pulse (HRP) portion of the IEEE 802.15.4-2015 technical specification. UWB techniques are showing potential to improve ranging accuracy down to a few centimeters, which is much better than existing global positioning system (GPS) or Wi-Fi based ranging techniques, such as lateration or Angle of Arrival (AoA). There are multiple ranging techniques outlined in the FIRa Consortium, including Time Difference of Arrival (TDOA). TDOA typically scales with the number of clients being simultaneously located, and is a promising solution.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates a grouping of UWB clusters with ranging anchors, according to one embodiment.

FIG. 1B illustrates a block of UWB clusters, according to one embodiment.

FIG. 2 is a block diagram illustrating a scheduler, according to one embodiment.

FIG. 3 is a flowchart illustrating UWB cluster scheduling, according to one embodiment.

FIG. 4 illustrates superclusters in an UWB block, according to one embodiment.

FIG. 5 is a flowchart illustrating forming superclusters from radio frequency (RF) isolated clusters, according to one embodiment.

FIG. 6 is a flowchart illustrating an alternative machine learning (ML) based discovery phase for UWB cluster scheduling, according to one embodiment.

FIG. 7 illustrates a learning phase as part of the ML discovery phase for UWB cluster scheduling, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

Embodiments include a method. The method includes identifying a plurality of clusters for ultra-wideband (UWB) time difference of arrival (TDOA) ranging, where each cluster of the plurality of clusters includes an initiating anchor to transmit a plurality of UWB messages to a plurality of wireless devices for TDOA ranging. The method further includes forming a first supercluster including a first two or more of the plurality of clusters, and a second supercluster including a second two or more of the plurality of clusters, based on determining that a respective initiating anchor associated with each of the two or more clusters in the first supercluster is radio frequency (RF) isolated from respective recipient anchors associated with each of the two or more clusters in the second supercluster. The method further includes conducting TDOA ranging using the plurality of clusters, based on scheduling transmission of UWB messages at least partially in parallel from initiating anchors in both the first and second superclusters.

Embodiments further include a non-transitory computer program product including one or more non-transitory computer readable media containing, in any combination, computer program code that, when executed by operation of any combination of one or more processors, performs operations. The operations include identifying a plurality of clusters for UWB TDOA ranging, where each cluster of the plurality of clusters includes an initiating anchor to transmit a plurality of UWB messages to a plurality of wireless devices for TDOA ranging. The operations further include forming a first supercluster including a first two or more of the plurality of clusters, and a second supercluster including a second two or more of the plurality of clusters, based on determining that a respective initiating anchor associated with each of the two or more clusters in the first supercluster is RF isolated from respective recipient anchors associated with each of the two or more clusters in the second supercluster. The operations further include conducting TDOA ranging using the plurality of clusters, based on scheduling transmission of UWB messages at least partially in parallel from initiating anchors in both the first and second superclusters.

Embodiments further include a system, including one or more processors and one or more memories storing a program, which, when executed on any combination of the one or more processors, performs operations. The operations include identifying a plurality of clusters for UWB TDOA ranging, where each cluster of the plurality of clusters includes an initiating anchor to transmit a plurality of UWB messages to a plurality of wireless devices for TDOA ranging. The operations further include forming a first supercluster including a first two or more of the plurality of clusters, and a second supercluster including a second two or more of the plurality of clusters, based on determining that a respective initiating anchor associated with each of the two or more clusters in the first supercluster is RF isolated from respective recipient anchors associated with each of the two or more clusters in the second supercluster. The operations further include conducting TDOA ranging using the plurality of clusters, based on scheduling transmission of UWB messages at least partially in parallel from initiating anchors in both the first and second superclusters.

### EXAMPLE EMBODIMENTS

As discussed above, TDOA is a promising solution for ranging using UWB. As one example, in TDOA wireless access points (APs), or other suitable network components, act as anchors, beaconing synchronization messages to be measured by a client (e.g., any other suitable wireless station (STA)). The TDOA of these messages is used to calculate the client's location within the coordinate system of the anchor infrastructure. To accurately solve this problem, anchors are grouped into clusters, which include a single initiator and multiple responders (e.g., at least four responders, in one example). In each group, one UWB Anchor is statically assigned as the Downlink TDOA (DT)-Initiator (which does the polling) and the remaining UWB APs are configured as responder anchors, which help with OTA ranging and respond to the initiator.

As the number of anchors and clients that need ranging scales, so does the number of clusters. To avoid interference, UWB ranging use is scheduled. For scaling purposes UWB APs are grouped into multiple clusters with spatial overlap to increase DL-TDOA coverage. Overlapping clusters can share anchors to facilitate cluster-to-cluster time synchronization, where common anchors are referred to as relay-anchors.

The FiRa specification mandates that one-way ranging (OWR) messages be sorted into 2 ms slots. If a system includes one initiator and four anchors, one round of exchanges between them will require a total of 10 ms of UWB airtime (e.g., polling is 2 ms, plus 4-times ranging from the anchors=4*2 ms=8 ms, giving a total of 10 ms to complete a ranging operation). FiRa is merely one example of an organization related to UWB standardization, and embodiments discussed herein are not limited to FiRa implementations. Any other suitable organization specification or standard (e.g., an omlox specification standard) or any other suitable implementation environment can be used.

This exchange can be frequent, as DT requires synchronization of anchors' time base to accurately calculate client location (as the calculation is based on time difference of arrival, which implies that all anchors work on the same clock or other time reference). In an embodiment, this is accomplished with a reference anchor. For each ranging block (e.g., a collection of exchange slots forming a reference unit) each UWB anchor synchronizes itself with the reference anchor every 200 ms.

Thus, as more and more clusters or groups are formed and the density of coverage is increased, UWB interference issues become a significant problem. Considering the need of every anchor to sync with the reference anchor every 200 ms (assuming each sync message takes 2 ms), if there were 50 APs in a block, 100 ms of the available 200 ms in each block would be used just for sync messaging, leaving only 50% of the UWB time for actual ranging (e.g., tags or clients sending ranging messages for asset tracking, in addition to clients using the anchor sync messages passively, for navigation purposes).

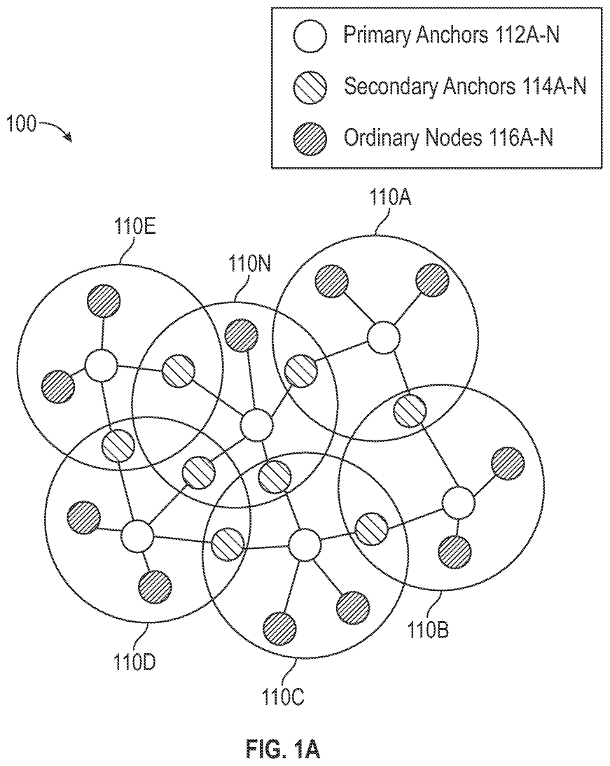

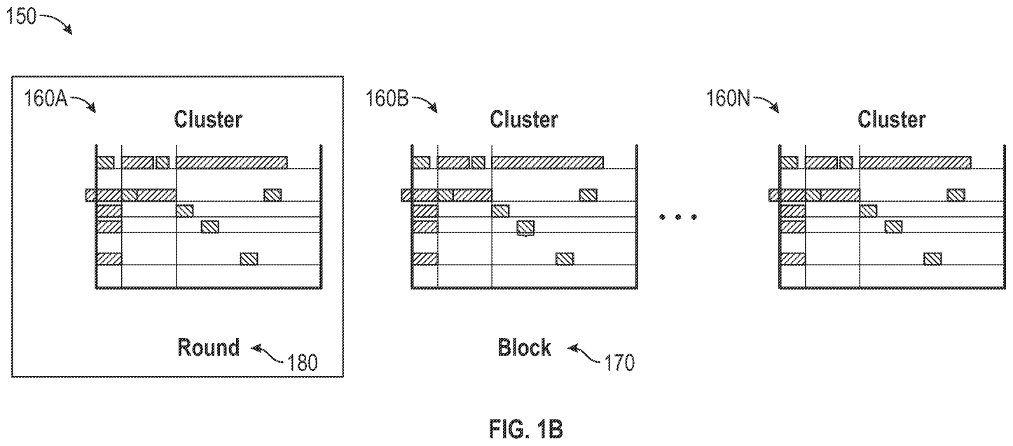

Considering that each cluster or group performs ranging in a set sequence, as discussed further below with regard to FIG. 1B, a cluster may also need to wait an undesirably long time before the next ranging window shows up. These issues may not be significant in sparse anchor deployments (e.g., an open space with only a few devices to track). In dense IoT environments (e.g., manufacturing), however, with challenging surroundings (e.g., metal or other challenging surroundings) resulting in a dense anchor deployment, and hundreds or thousands of tags to track, these solutions may not be sufficient because they do not scale, and the airtime is consumed with synchronization messages.

One or more embodiments disclosed herein provide a two stage improvement. First, a discovery mechanism can be used to identify clusters that are RF isolated and form superclusters of RF isolated clusters. Second, a scheduler may be used to allow parallel ranging operations by the superclusters, while avoiding UWB interference. This is discussed further, below, with regard to FIGS. 3-7.

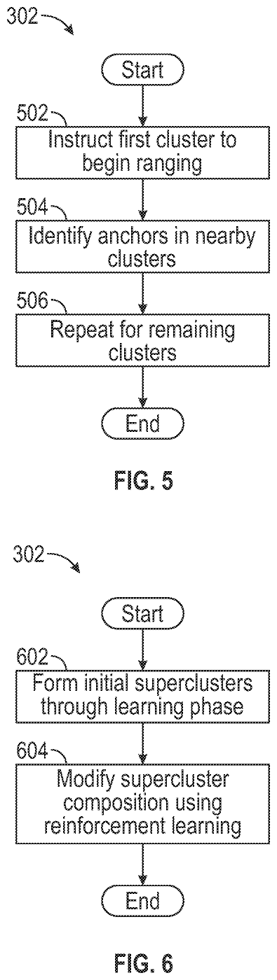

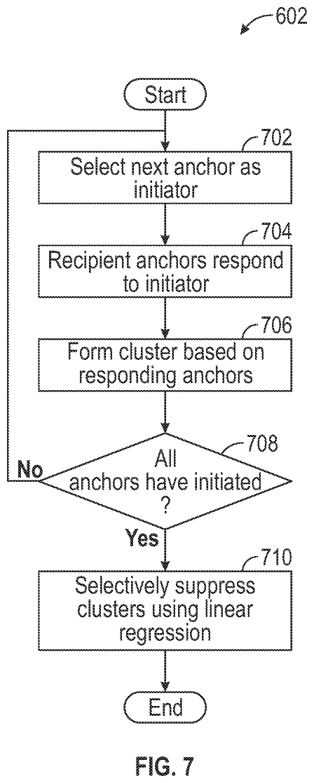

In one embodiment, this can be done through a discovery process iteratively analyzing cluster separation and forming superclusters. This is discussed below with regard to FIG. 5. While this may work for relatively simple deployments, it may not be suitable for complex or crowded deployments. Alternatively, or in addition a two-step approach can be used, in which a linear regressor is used to form initial superclusters and a suitable ML technique (e.g., reinforcement learning) is used to modify superclusters as conditions change over time. This is discussed further, below, with regard to FIGS. 6-7.

FIG. 1A illustrates a grouping of UWB clusters with ranging anchors, according to one embodiment. As discussed above, for TDOA ranging in UWB, anchors (e.g., APs beaconing synchronization messages to clients) are grouped into clusters. In an embodiment, a cluster includes a single initiator and multiple responders (e.g., at least four responders). As the number of anchors and clients scales, so does the number of clusters. While embodiments herein are focused on APs acting as anchors, this is merely an example. Any suitable network component can act as an anchor for UWB ranging. For example, an independent anchor could be used.

A computing environment 100 includes six clusters 110A-N. This is merely an example, and any suitable number of clusters can be used. Each of the clusters 110A-N includes a respective primary anchor (e.g., one of the primary anchors 112A-N). Further, each of the clusters includes a number of secondary anchors (e.g., one or more of the secondary anchors 114A-N). In an embodiment, each of the clusters 110A-N includes one primary anchor, and the primary anchor is not shared between clusters. By contrast, one or more of the secondary anchors 114A-N are shared across multiple clusters, and a given cluster can have multiple secondary anchors. As discussed above, in an embodiment the secondary anchors 114A-N can be used to facilitate cluster-to-cluster time synchronization. Further, each cluster includes one or more ordinary nodes (e.g., one or more of the ordinary nodes 116A-N). For example, the ordinary nodes 116A-N can be responding APs that do not act as initiators for TDOA ranging. In an embodiment, an ordinary node is a secondary anchor that belongs to only one cluster. For example, each cluster 110A-N can have a primary anchor (e.g., to trigger exchanges) and secondary anchors that respond to triggers from the primary anchor. Some, or all, of these secondary anchors can belong to multiple clusters (e.g., responding to triggers from more than one primary anchor). These are merely examples, and any suitable configuration can be used.

As discussed above, in an embodiment the clusters 110A-N facilitate TDOA ranging by having each of the anchors (e.g., the primary anchors 112A-N) initiate polling messages to clients, and having the clients respond. The time difference for responses is used for ranging.

FIG. 1B illustrates a block of UWB clusters, according to one embodiment. A block 170 (e.g., a downlink TDOA (DT) block) includes a number of clusters 160A-N (e.g., UWB clusters as discussed above in relation to FIG. 1A).

In an embodiment, the block 170 is a period of time, divided in a whole number of ranging rounds. For example, the round 180 (e.g., a DT round) is a ranging round that contains enough time slots for all the exchanges between the participating anchors (e.g., a primary anchor and one or more secondary anchors), in the cluster, to be completed. In an embodiment, the primary anchor allocates time slots for each of the secondary anchors to respond. Thus, the round 180 contains enough time slots for all exchanges between participating anchors in the cluster 160A. In an embodiment, each block (e.g., the block 170) is defined by a single initiator anchor to perform synchronization among all the members (e.g., secondary anchors) that communicate within the block. As each anchor, for accuracy reasons, needs to sync frequently (e.g., every 200 ms), then each round is expected to last for one synchronization period (e.g., 200 ms), and the initiator anchor may define blocks of n rounds.

As discussed above, as more and more clusters 160A-N are added, the density of UWB increases. Further, as more UWB anchors are deployed, all anchors in a given cluster must continue to resync (e.g., clock sync) with a reference anchor frequently (e.g., every 200 ms), but the blocks between clusters are not synchronized, and cross allocation starts to reduce the efficiency of the procedure.

Thus, for each round, the amount of time of non-interfering actual ranging diminishes as more and more clusters are added to a given area. The UWB reference anchor or scheduler ensures that only one cluster performs ranging at a time to prevent UWB interference from occurring within the cluster, but not between clusters. This results in a pattern of serialized one-cluster-at-a-time ranging operations, where one cluster performs ranging while all the other clusters must remain quiet and wait for their turn. This is inefficient, and sequential block ranging can that each cluster will need to wait unnecessarily long while the entire rotation is performed by the scheduler. As discussed below, in relation to FIGS. 3-7, this can be improved through use of a scheduler with a discovery mechanism to identify when clusters are RF isolated, from each other, that allows parallel ranging operations among RF isolated clusters (e.g., ranging operations at least partially in parallel).

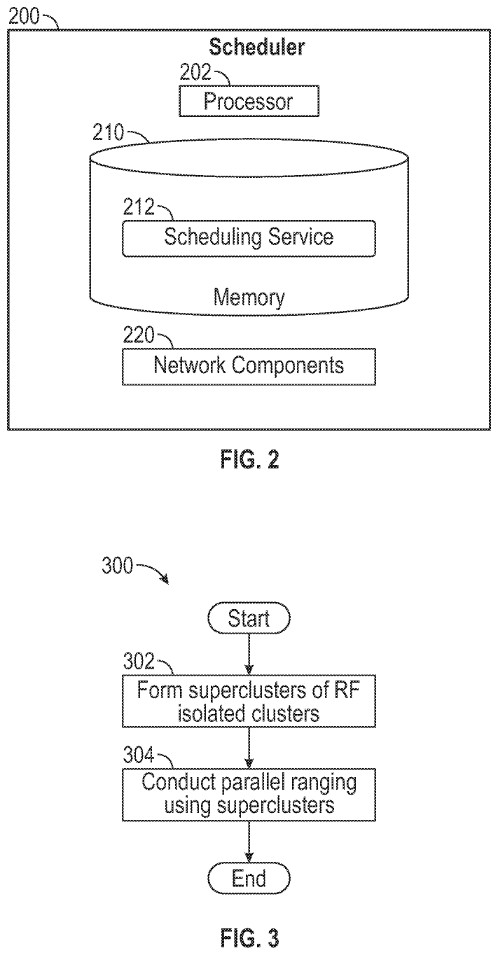

FIG. 2 is a block diagram illustrating a scheduler 200, according to one embodiment. The scheduler 200 includes a processor 202, a memory 210, and network components 220. The processor 202 generally retrieves and executes programming instructions stored in the memory 210. The processor 202 is included to be representative of a single central processing unit (CPU), multiple CPUs, a single CPU having multiple processing cores, graphics processing units (GPUs) having multiple execution paths, and the like.

The network components 220 include the components necessary for the scheduler 200 to interface with a communication network, as discussed above in relation to FIGS. 1A-B. For example, the network components 220 can include wired, WiFi or cellular network interface components and associated software to facilitate communication between the scheduler 200, one or more APs (e.g., one or more UWB TDOA anchors discussed above in relation to FIG. 1A) and other suitable components.

Although the memory 210 is shown as a single entity, the memory 210 may include one or more memory devices having blocks of memory associated with physical addresses, such as random access memory (RAM), read only memory (ROM), flash memory, or other types of volatile and/or non-volatile memory. The memory 210 generally includes program code for performing various functions related to use of the scheduler 200. The program code is generally described as various functional “applications” or “modules” within the memory 210, although alternate implementations may have different functions and/or combinations of functions.

Within the memory 210, a scheduling service 212 facilitates forming and using superclusters (e.g., RF isolated UWB clusters) for UWB ranging. This is discussed in further detail in subsequent figures.

FIG. 3 is a flowchart 300 illustrating UWB cluster scheduling, according to one embodiment. At block 302, a scheduling service (e.g., the scheduling service 212 illustrated in FIG. 2) forms superclusters of RF isolated clusters. In an embodiment, the scheduling service takes control of the block definition (e.g., the block 170 illustrated above in relation to FIG. 1B), and begins a discovery phase. In one embodiment, the scheduling service identifies RF isolated clusters by iteratively instructing each cluster to conduct ranging, and identifying nearby clusters that receive the ranging messages. This is discussed further, below, with regard to FIG. 6. These RF isolated clusters can be arranged into superclusters, to allow simultaneous ranging across clusters. This is discussed below with regard to FIG. 5.

While this technique to identify RF isolated clusters and form superclusters works in some scenarios, it may not work in complex and changing deployments (e.g., contiguous deployment of APs in a warehouse). RF isolation from one cluster to other clusters is evaluated from the point of view of each individual cluster. For example, one ranging cluster on the north side of a building may not hear another cluster on the south side of the building, even if each cluster member could hear the nearby cluster in a non-interrupted north-south chain. Thus, grouping of clusters into superclusters is not a problem of geometry, but rather, each individual cluster will have its own point of view which other clusters it is RF isolated from. Thus identifying RF isolated clusters and forming superclusters becomes a very difficult task for the scheduler (e.g., an NP hard problem), with an almost endless set of combinations

Alternatively, or in addition, another technique can be used to identify RF isolated clusters and form superclusters. In an embodiment, a two-step approach can be used with a linear regressor and reinforcement learning as the mechanism where the scheduler interacts with each cluster to determine a preferred (e.g., optimal) grouping of clusters into supercluster sets. The learning mechanism can use, for example, response failures and signal to noise ratio (SNR) of received pulses in the learning process, and can use a suitable ML technique (e.g., reinforcement learning) to form superclusters. This is discussed further, below, with regard to FIGS. 6-7.

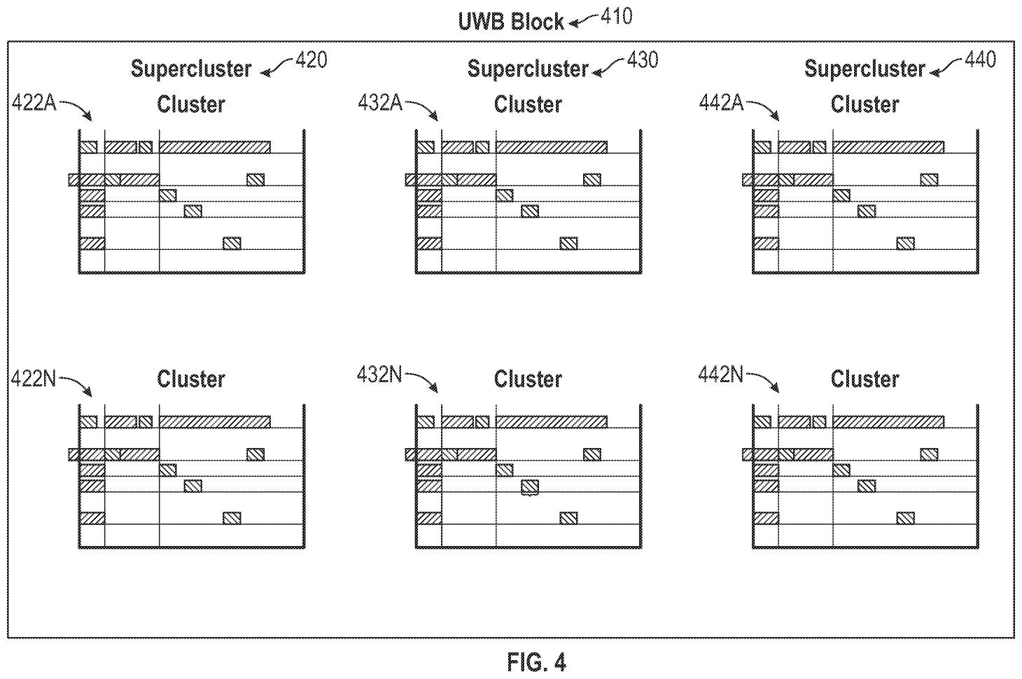

At block 304, the scheduling service (or any other suitable software service) conducts parallel ranging using superclusters. For example, as illustrated in FIG. 4, a block can be divided and interleaved among members of a supercluster. This can allow the scheduling service to conduct simultaneous ranging while reducing (or eliminating) risk of UWB interference.

FIG. 4 illustrates superclusters in an UWB block, according to one embodiment. In an embodiment, an UWB block 410 includes three superclusters 420, 430, and 440. Each of the superclusters 420, 430, and 440 includes a number of clusters. For example, the supercluster 420 includes a number of clusters 422A-N. The supercluster 430 includes a number of clusters 432A-N. The supercluster 440 includes a number of clusters 442A-N. These are merely examples, and any number of superclusters can be used, with any number of clusters associated with each supercluster.

As discussed above in relation to FIG. 3, in an embodiment the superclusters 420, 430, and 440 include RF isolated clusters. Thus, the clusters 422A-N in the supercluster 420 are not RF isolated, but the clusters between the superclusters 420, 430, and 440 are RF isolated. This allows for simultaneous ranging by the superclusters 420, 430, and 440. This simultaneous ranging greatly reduced the overhead and time needed for sequential ranging by the clusters (e.g., as compared with iterating through each of the clusters sequentially, as discussed above in relation to FIG. 1B).

FIG. 5 is a flowchart illustrating forming superclusters from RF isolated clusters, according to one embodiment. In an embodiment, FIG. 5 corresponds with one embodiment for block 302 illustrated in FIG. 3. At block 502, a scheduling service (e.g., the scheduling service 212 illustrated in FIG. 2) instructs a first cluster to being ranging. For example, the scheduling service can instruct a cluster 110A illustrated in FIG. 1A to begin ranging. An anchor in the cluster 110A can transmit UWB pulse messages (e.g., polling messages), and nodes in nearby clusters can listen.

At block 504, the scheduling service identifies anchors in nearby clusters. As discussed above, an anchor in the initiating cluster (e.g., the cluster 110A) transmits UWB pulse messages, or any other suitable polling messages. For all anchors (e.g., anchors in nearby clusters) where the pulse message is heard above a predetermined received signal strength indication (RSSI) level (e.g., it is not RF isolated), the cluster to which the anchor belongs is organized into a supercluster (e.g., a supercluster is formed of clusters that are within range of each other and not RF isolated).

At block 506, the scheduling service repeats for remaining clusters. In an embodiment, ranging is initiated for each cluster (e.g., each of the clusters 110A-N illustrated in FIG. 1A). Anchors that are not RF isolated are organized into a shared supercluster, and anchors that are RF isolated are organized into differing superclusters. In this way, the block is divided and interleaved among the members of the supercluster. This will allow multiple simultaneous ranging to be performed within a single bock by the scheduling service without UWB interference.

FIG. 6 is a flowchart illustrating an alternative machine learning (ML) based discovery phase for UWB cluster scheduling, according to one embodiment. In an embodiment, FIG. 6 corresponds with another embodiment for block 302 illustrated in FIG. 3. At block 602, a scheduling service (e.g., the scheduling service 212 illustrated in FIG. 2) forms initial superclusters clusters through a learning phase.

In an embodiment, during the learning phase the scheduling service instructs each anchor (e.g., each primary anchor for a cluster 110A-N illustrated in FIG. 1A) to act in turn as an initiator (e.g., transmit UWB pulse poling messages). All anchors in RF range answer. The answering anchors, and initiator, form a first cluster. In an embodiment, the process repeats, resulting, for n anchors on a given floor, into n clusters, each centered on a given anchor. Then, a linear regressor selectively suppresses one cluster, and measures if the associated center anchor is isolated (e.g., an outlier), or is still member of another cluster. This is discussed further, below, with regard to FIG. 7.

At block 604, the scheduling service modifies the composition of superclusters using reinforcement learning. In an embodiment, the initial superclusters formed at block 604 are only stable while the RF environment does not change. However, in the real world, it is common for the RF conditions to change over time. For example, obstacles can be added or removed, changing the RF conditions.

In an embodiment, the composition of the superclusters can be modified by allowing the scheduling service to pseudo-randomly perform simultaneously UWB ranging operations with individual clusters to determine which ones still have RF visibility with each other. A suitable ML model (e.g., a reinforcement learning ML model) can be configured (e.g., trained, if the ML model is supervised) to avoid combining clusters with RF visibility.

For example, a reinforcement learning policy gradient can be trained to avoid combining any two clusters with RF visibility, going forward into the future. When two clusters which have good isolation are tested, the reinforcement learning ML model can be trained to actively add these clusters into a supercluster group (e.g., encouraging or discouraging formation of a supercluster based on detected interference). The scheduling service repeats this process iteratively with various combinations of cluster ranging until the reinforcement leaning policy gradient converges, producing an optimal (e.g., maximum) set of superclusters. The ultimate reward of this algorithm (e.g., the reinforcement learning reward shaping) is to maximize the number of the superclusters, allowing as much parallel UWB ranging as possible. As a result, the scheduling service discovers which clusters may be grouped together such that a maximum number of clusters can perform simultaneous ranging without risk of interference.

FIG. 7 illustrates a learning phase as part of the ML discovery phase for UWB cluster scheduling, according to one embodiment. In an embodiment, FIG. 7 corresponds with block 602 illustrated in FIG. 6. At block 702 a scheduling service (e.g., the scheduling service 212 illustrated in FIG. 2) selects a next anchor as the initiator. As discussed above, in an embodiment each anchor acts in turn as an initiator. The scheduling service can select the next anchor, which has not yet taken its turn as an initiator.

At block 704, the recipient anchors respond to the initiator. In an embodiment, the initiating anchor transmits UWB pulses (or any other suitable polling messages). The recipient anchors (e.g., recipient anchors that hear the pulses above a threshold RSSI) respond to the initiating anchor.

At block 706, the scheduling service forms a cluster based on the responding anchors. In an embodiment, the cluster includes the initiating anchor and each of the responding anchors.

At block 708, the scheduling service determines whether all anchors have initiated (e.g., taken a turn as the initiator). If not, the flow returns to block 702 and the scheduling service selects the next anchor as initiator. If so, the flow proceeds to block 708.

At block 710, the scheduling service selectively suppresses clusters using linear regression. In an embodiment, a linear regressor selectively suppresses one cluster, and measures if the associated center anchor is isolated (e.g., is an outlier), or is still a member of another cluster. Thus the regression process becomes a combinatorial algorithm, that attempts to maximize the number of cluster suppressed (e.g., minimize the number of clusters left), while minimizing the number of outliers. At the end of the regression, m (m<=n) clusters are left, with no outlier (each outlier, if any left, forms its own cluster).

Further, while embodiments discussed above are largely discussed at the cluster level (e.g., forming superclusters of multiple clusters), this is merely one example. Alternatively, or in addition, one or more embodiments can be used at the anchor level. For example, individual anchors could be grouped, either as a supplement to forming superclusters or as an alternative.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
identifying a plurality of clusters for ultra-wideband (UWB) time difference of arrival (TDOA) ranging, wherein each cluster of the plurality of clusters comprises an initiating anchor to transmit a plurality of UWB messages to a plurality of wireless devices for TDOA ranging;
forming a first supercluster comprising a first two or more of the plurality of clusters, and a second supercluster comprising a second two or more of the plurality of clusters, based on determining that a respective initiating anchor associated with each of the two or more clusters in the first supercluster is radio frequency (RF) isolated from respective recipient anchors associated with each of the two or more clusters in the second supercluster; and
conducting TDOA ranging using the plurality of clusters, based on scheduling transmission of UWB messages at least partially in parallel from initiating anchors in both the first and second superclusters.

2. The method of claim 1, wherein forming the first supercluster comprising the first two or more of the plurality of clusters and the second supercluster comprising a second two or more of the plurality of clusters comprises:
iteratively selecting a plurality of anchors in each cluster, of the plurality of clusters, to act as an initiator;
transmitting UWB messages from each of the selected initiator anchors; and
identifying anchors that are RF isolated based on monitoring responses to the transmitted UWB messages from the selected initiator anchors.

3. The method of claim 2, further comprising:
forming a second plurality of clusters based on the identified anchors that are RF isolated; and
forming the first and second superclusters based on selectively suppressing clusters within the second plurality of clusters.

4. The method of claim 3, wherein the selectively suppressing clusters comprises:
using a linear regressor to selectively suppress a respective anchor associated with each cluster within the second plurality of clusters.

5. The method of claim 1, further comprising:
modifying a composition of the first supercluster, during operation of the plurality of clusters, based on using machine learning (ML).

6. The method of claim 5, wherein modifying a composition of the first supercluster, during operation of the plurality of clusters, based on using ML comprises:
using reinforcement learning to identify the composition of the first supercluster, based on detected interference between clusters.

7. The method of claim 6, wherein using reinforcement learning to identify the composition of the first supercluster, based on detected interference between clusters comprises:
performing simultaneous UWB ranging operations within at least some of the plurality of clusters;
identifying interference based on the simultaneous UWB ranging operations; and
using a reinforcement learning policy gradient to at least one of: (i) encourage or (ii) discourage combining clusters into a supercluster based on the identified interference.

8. The method of claim 1, further comprising:
forming the first and second superclusters using a linear regressor; and
modifying a composition of the first supercluster, during operation of the plurality of clusters, based on using ML.

9. The method of claim 1, wherein determining that a respective initiating anchor associated with each of the two or more clusters in the first supercluster is RF isolated from respective recipient anchors associated with each of the two or more clusters in the second supercluster comprises:
determining that a received signal strength indication (RSSI) for messages from the respective initiating anchors to the respective recipient anchors is at or below a threshold value.

10. The method of claim 1, wherein each of the anchors comprises a wireless access point (AP).

11. A non-transitory computer program product comprising:
one or more non-transitory computer readable media containing, in any combination, computer program code that, when executed by operation of any combination of one or more processors, performs operations comprising:
identifying a plurality of clusters for ultra-wideband (UWB) time difference of arrival (TDOA) ranging, wherein each cluster of the plurality of clusters comprises an initiating anchor to transmit a plurality of UWB messages to a plurality of wireless devices for TDOA ranging;
forming a first supercluster comprising a first two or more of the plurality of clusters, and a second supercluster comprising a second two or more of the plurality of clusters, based on determining that a respective initiating anchor associated with each of the two or more clusters in the first supercluster is radio frequency (RF) isolated from respective recipient anchors associated with each of the two or more clusters in the second supercluster; and
conducting TDOA ranging using the plurality of clusters, based on scheduling transmission of UWB messages at least partially in parallel from initiating anchors in both the first and second superclusters.

12. The non-transitory computer program product of claim 11, wherein forming the first supercluster comprising the first two or more of the plurality of clusters and the second supercluster comprising a second two or more of the plurality of clusters comprises:
iteratively selecting a plurality of anchors in each cluster, of the plurality of clusters, to act as an initiator;
transmitting UWB messages from each of the selected initiator anchors; and
identifying anchors that are RF isolated based on monitoring responses to the transmitted UWB messages from the selected initiator anchors.

13. The non-transitory computer program product of claim 12, further comprising:
forming a second plurality of clusters based on the identified anchors that are RF isolated;
forming the first and second superclusters based on selectively suppressing clusters within the second plurality of clusters, comprising:
using a linear regressor to selectively suppress a respective anchor associated with each cluster within the second plurality of clusters.

14. The non-transitory computer program product of claim 11, further comprising:
modifying a composition of the first supercluster, during operation of the plurality of clusters, based on using machine learning (ML), comprising:
using reinforcement learning to identify the composition of the first supercluster, based on detected interference between clusters.

15. The non-transitory computer program product of claim 11, further comprising:
forming the first and second superclusters using a linear regressor; and
modifying a composition of the first supercluster, during operation of the plurality of clusters, based on using ML.

16. A system, comprising:
one or more processors; and
one or more memories storing a program, which, when executed on any combination of the one or more processors, performs operations, the operations comprising:
identifying a plurality of clusters for ultra-wideband (UWB) time difference of arrival (TDOA) ranging, wherein each cluster of the plurality of clusters comprises an initiating anchor to transmit a plurality of UWB messages to a plurality of wireless devices for TDOA ranging;
forming a first supercluster comprising a first two or more of the plurality of clusters, and a second supercluster comprising a second two or more of the plurality of clusters, based on determining that a respective initiating anchor associated with each of the two or more clusters in the first supercluster is radio frequency (RF) isolated from respective recipient anchors associated with each of the two or more clusters in the second supercluster; and
conducting TDOA ranging using the plurality of clusters, based on scheduling transmission of UWB messages at least partially in parallel from initiating anchors in both the first and second superclusters.

17. The system of claim 16, wherein forming the first supercluster comprising the first two or more of the plurality of clusters and the second supercluster comprising a second two or more of the plurality of clusters comprises:
iteratively selecting a plurality of anchors in each cluster, of the plurality of clusters, to act as an initiator;
transmitting UWB messages from each of the selected initiator anchors; and
identifying anchors that are RF isolated based on monitoring responses to the transmitted UWB messages from the selected initiator anchors.

18. The system of claim 17, further comprising:
forming a second plurality of clusters based on the identified anchors that are RF isolated;
forming the first and second superclusters based on selectively suppressing clusters within the second plurality of clusters, comprising:
using a linear regressor to selectively suppress a respective anchor associated with each cluster within the second plurality of clusters.

19. The system of claim 16, further comprising:
modifying a composition of the first supercluster, during operation of the plurality of clusters, based on using machine learning (ML), comprising:
using reinforcement learning to identify the composition of the first supercluster, based on detected interference between clusters.

20. The system of claim 16, further comprising:
forming the first and second superclusters using a linear regressor; and
modifying a composition of the first supercluster, during operation of the plurality of clusters, based on using ML.
